(19) United States
(12) Patent Application Publication
(10) Pub. No.: US 2003/0025363 A1
(43) Pub. Date: Feb. 6, 2003

(54) Ventilated bicycle saddle

(76) Inventor: Raffaele Gaggiola, Mestrino (IT)

Correspondence Address: COUDERT BROTHERS, ATTN: LEWIS REFF, 1114 AVENUE OF THE AMERICAS, NEW YORK, NY, 10036, US

(21) Appl. No.: 09/920,146

(22) Filed: Aug. 1, 2001

(51) Int. Cl. B62J 1/00

(52) U.S. Cl. 297/195.1; 297/202

(57) ABSTRACT

The present invention is directed to a ventilated bicycle saddle which enables air to flow along the top surface of the saddle while the bicycle is in motion. Specifically, the saddle of the present invention has a seat surface on which a rider sits. The top of the seat surface has a vent recess. An air distribution channel is positioned underneath the seat surface. The air distribution channel is engaged with one or more discharge openings disposed within the vent recess so that while the bicycle moves forwardly, air flows through the air distribution channel, through the air discharge openings disposed within the vent recess and then through the rear portion of the seat surface.

### FIELD OF THE INVENTION

This invention relates to a bicycle saddle, and more specifically, to a ventilated bicycle saddle which enables air to flow freely along the top surface of the saddle while the bicycle is in motion.

### BACKGROUND OF THE INVENTION

Saddle discomfort is a major problem that cyclists experience everyday. On source of discomfort is due to trapped perspiration generated from the cyclist while the bicycle is moving forward. Specifically, perspiration is trapped between the top surface of the saddle and the cyclist's buttocks and/or genitals. This, in turn, raises the surface temperature of the saddle, making the saddle uncomfortable to the cyclist.

### SUMMARY OF THE INVENTION

The object of the present invention is to provide a bicycle saddle that provides a positive air flow through the seat and along a recess positioned on the top surface of the saddle. This free flow of air provides a cooling effect on the seat surface, thus making the saddle more comfortable to the rider while the bicycle is in motion.

### BRIEF DESCRIPTION OF THE DRAWING

For further understanding of the nature and objects of the present invention, reference should be had to the following detailed description, taken in conjunction with the accompanying drawings wherein:

FIG. 1 shows a top view of an embodiment of the present invention;

FIG. 2 shows a side view of an embodiment of the present invention;

FIG. 3 shows a side view of an embodiment of the present invention;

FIG. 4 shows a side view of an embodiment of the present invention;

FIG. 5 shows a side view of an embodiment of the present invention; and

FIG. 6 shows a bottom view of an embodiment of the present invention.

### DETAILED DESCRIPTION OF THE INVENTION

The present invention is directed to a ventilated bicycle saddle (1) having a rigid support base (26). The support base has an upper surface (27) and bottome surface (28). The rigid support base can be made of various materials, including but not limited to thermoplastic resin, titanium, aluminum or any other light weight, but sturdy material.

A seat surface (2), on top of which a rider sits, is supported by and positioned above the base (26). The seat surface (2) has a front portion (3) and a rear portion (4). When the saddle of the present invention is installed on a vehicle, the front portion (3) of the seat surface is oriented at least partly in a direction of forward travel of the vehicle (5). The seat surface may be covered with any suitable material known by those skilled in the art, including but not limited to fabric, animal skin or a material which limits the cyclist's perspiration. A longitudinal center axis (6) extends through the front portion (3) of the seat surface (2) to the rear portion thereof (4), thus defining two substantially symmetrical halves of the seat surface.

A vent recess (7) is positioned on top of the seat surface (2). The vent recess (7) directs air flow toward the rear portion (4) of the seat surface (2) when the bicycle is in motion. Specifically, the vent recess (7) extends down the center of the seat surface (2) along the longitudinal center axis (6) and over at least part of the rear portion (4) of the seat surface (2). The width of the recess may vary according to the rider's comfort needs, but may range from approximately 1 to 50 mm, preferably about 5 to 20 mm, and more preferably about 10 to 15 mm. One or more air discharge openings (8) are disposed within the vent recess (7). The size of the one or more openings may range from approximately 0.20 to 15 mm, preferably about 1 to 10 mm, and more preferably about 5 mm. The size of each opening may be the same or they may vary from one to the other.

The bicycle saddle of the present invention has an air distribution channel (10) positioned beneath the seat surface (2). This channel may be positioned between the seat surface (2) and the rigid support base (26) or it may be positioned and/or attached to the bottom surface (28) of the rigid support base (26). The air distribution channel has a first portion (11) and a second portion (12). The first portion (11) of the air distribution channel (10) has an air-intake component (13) for directing air flow into the air distribution channel (10). The air-intake component (13) has one or more apertures (14) oriented at least partly in the direction of forward travel of the bicycle (5). The second portion (12) of the air distribution channel (10) is engaged with one or more air discharge openings (8) disposed within the vent recess (7) so that, while the vehicle moves forward, air flows through the at least one aperture of the air intake components (10) through one or more of the air discharge openings (8) disposed within the vent recess (7), and then through and along the vent recess (7) toward the rear portion (4) of the seat surface (2). This free flow of air provides a cooling effect on the seat surface and/or the buttocks and groin area of the rider, thus making the saddle more comfortable to the rider while the bicycle is in motion.

The air distribution channel (10) may be made of any suitable material, including but not limited to plastic, rubber, aluminum. It may be removable from the saddle, thereby giving the rider the option to ride with or without ventilation. The rear portion (4) of the seat surface (2) may be made of a flexible material to further promote comfort to the rider.

In another embodiment of the present invention, the rigid support base may be attached to a rigid frame (15). Rails may be added to the rigid frame (15) as a means to connect the saddle to a seat post by any clamping means known to those skilled in the art. Such frame may be made of titanium or any other high strength alloy or materials known to those skilled in the art. Also, interchangeable elastomeric material (16) could be positioned between the seat surface (2) and the rigid base (26). Also, a flexible elastomer padding may be positioned on top of the base (26). The elastomer padding may be attached to the base (26)

In another embodiment of the present invention, the one or more air discharge openings (8) are positioned in or about the rear portion (4) and/or front portion (3) of the seat surface (2). The air distribution channel (10) is engaged with the air-discharge openings (8) so that air flows through these openings as the vehicle moves forward. Additionally, the air-distribution channel (10) may extend along the longitudinal center axis (6) essentially over the entire length of the seat surface (2).

In another embodiment of the present invention, the first portion (11) of the air distribution channel (10) comprises a plurality of apertures. Also, one or more air discharge openings (8) maybe disposed in or about the rear portion (4) of the seat surface (2).

The dimensions of the saddle of the present invention may vary depending on the rider's preference and the type of bike on which the saddle is attached. In one alternate embodiment of the present invention, the length of the saddle (17) may be approximately 300 millimeters and the width (18) is approximately 50 millimeters measured across the front portion (3) of the seat surface (2). It should be understood that the present invention is adapted and intended to include a varied range of sizes and dimensions, particularly the length and width of the saddle. The dimensions stated herein are described for illustrative purposes and are not limiting.

In another embodiment of the present invention, the air distribution channel (10) may have a third portion (19) which has one or more apertures (20) facing in the opposite direction of forward travel (5). Said aperture enables air to flow through the underside of the rear portion (4) of the seat surface (2) while the bicycle moves forwardly.

In another embodiment of the present invention, the saddle may contain a system by which it can mold itself to the contours of the cyclist's individual shape. Specifically, a molding material (22) may be disposed inside the bicycle saddle assembly (23). For example, these materials may be positioned between rigid support base (26) and seat surface (2). One or more of these materials may also be positioned underneath the rigid support base (26), and then delivered underneath the seat surface (2) by a suitable means, such as a channel. Such material may include but are not limited to silicon, polyurethane gel or silica foam. The molding process may be activated the first time the seat is used by the cyclist. In one such embodiment, the molding process can be initiated by a lever (24) protruding from under the saddle assembly (23). Here, the lever is pulled while the cyclists sits on the seat surface (2). When the lever is pulled, the catalyst (25) is released inside the saddle assembly and mixes with the molding material (22), thereby initiating the molding process. As the molding material polymerizes, it causes the top surface of the bicycle saddle to mold itself to the cyclist's individual shape.

Other means by which the molding materials may be mixed together include, but are not limited to using a thin bag containing isocyante. The bag is positioned inside another bag containing polyol. The volume ratio between the isocyante and the polyol may vary according to the desired molding sought, but preferably such ratio is 1:25, respectively. When the rider sits on the saddle, the pressure from the rider's weight breaks the bag of isocyante, but not the bag containing the polyol. The rupturing of the inner bag releases the isocyante in the bag containing polyol.

In the molding process, approximately 20 to 120 grams of polyol may be used, together with approximately 1 to 40 grams of isocyante. Preferably, about 80 grams of polyol is combined with about 20 grams of isocyante.

It should be understood that the molding process of the present invention may be utilized in any saddle assembly, irrespective of whether the saddle has a ventilation system, such as the system described herein.

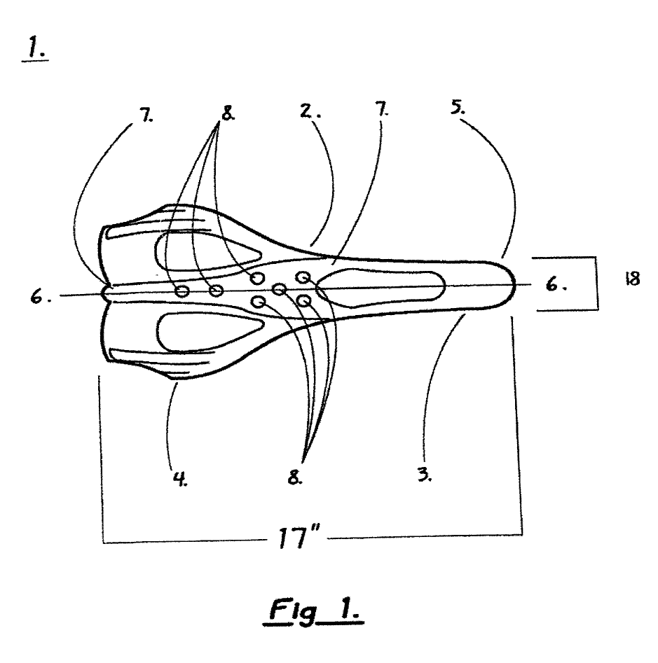

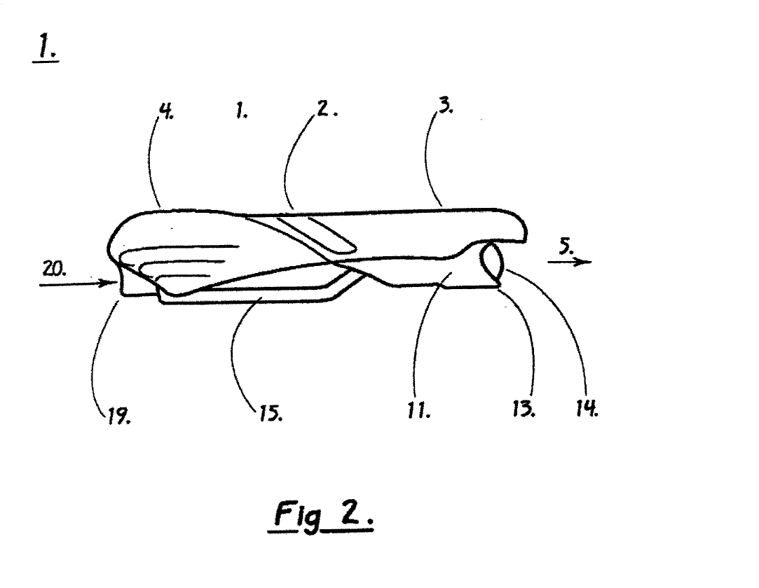

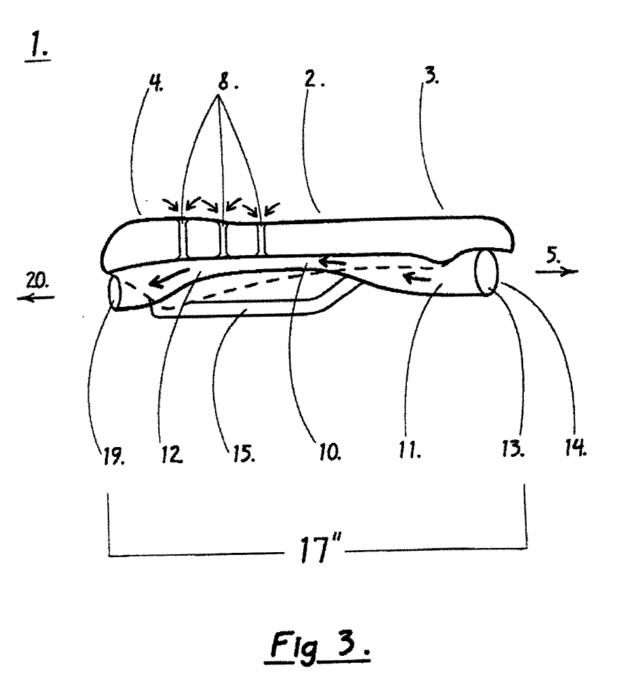

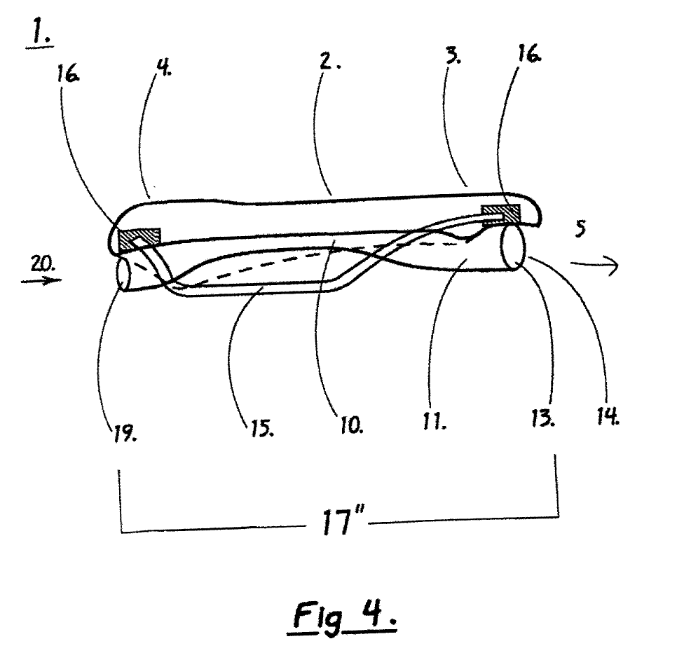

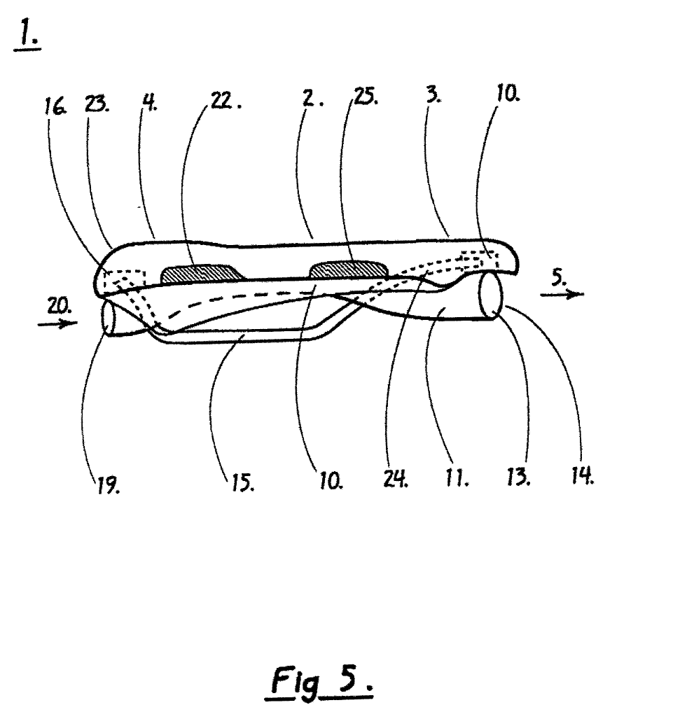

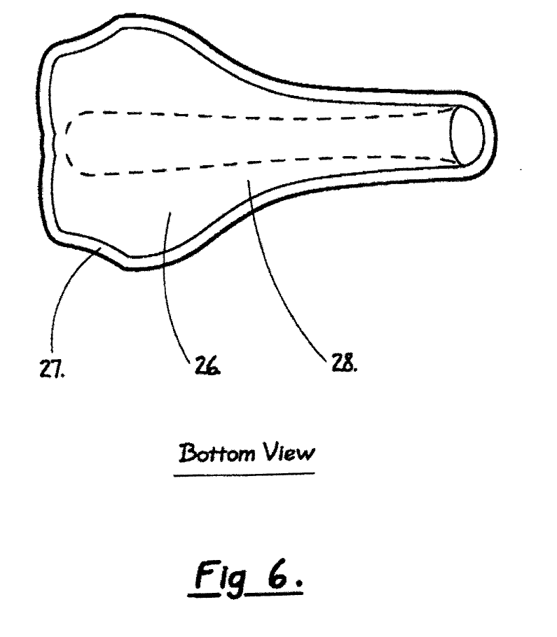

In an alternative embodiment of the present invention, the seat surface (2) may be generally pear shaped (See e.g., FIG. 1) in that the edges of the rear portion (4) of the seat surface (2) are generally spherical or rounded and tapered toward the front portion (3) of the seat surface (2). It should be understood that the shape of the seat surface in FIGS. 1-6 is shown for purposes of illustration, and not limitation.

While the present invention has been described in connection with the embodiments described above, it will be understood that the present invention is capable of further modification, and this application, including the appended claims, are intended to cover any variations, uses, or adaptations of the present invention following, in general, the principles of the disclosures set forth herein and including such departures from the present disclosures that come with known or customary practice in the art to which the invention pertains.

Further, while various embodiments of the present invention have been described above, it should be understood that they have been presented by way of example only, and not by limitation. Thus, the breadth and scope of the present invention should not be limited by any of the above described alternative embodiments.

I claim:

1. A ventilated bicycle saddle, comprising:
(a) a generally pear shaped, flexible seat surface on top of which a cyclist sits;
(b) the seat surface having a front portion and a rear portion; the front portion oriented at least partly in a direction of forward travel of the bicycle;
(c) a longitudinal axis extends along the center of the seat surface from the front portion to the rear portion of said seat surface, thus defining two substantially symmetrical halves of the seat surface;
(d) a vent recess being positioned on top of the seat surface; the vent recess extends along the longitudinal axis and over at least part of the upper portion of the seat surface; at least one air discharge opening being disposed within the vent recess;
(e) an air distribution channel comprising a first portion and a second portion; the air distribution channel being positioned beneath the seat surface;
(f) the first portion of the air distribution channel comprsing an air-intake component for directing air flow into the air distribution channel; said air in-take component having at least one aperture oriented at least partly in the direction of forward travel of the bicycle;
(g) the second portion of the air distribution channel being engaged with the at least one air discharge opening so that, while the vehicle moves forward, air flows through the at least one aperture of the air intake component, through the at least one air discharge opening disposed within the vent recess on top of the seat surface, and then along the vent recess toward the rear portion of the seat surface.

2. The ventilated bicycle saddle of claim 2, wherein the seat surface is positioned above a support base; the support base having and upper surface and bottome surface; the air distribution channel is attached to the bottom surface of the support base.

3. The ventilated bicycle saddle of claim 1, wherein the seat surface has a plurality of air discharge openings disposed within the vent recess.

4. The ventilated bicycle saddle of claim 1, wherein the dimensions of the air-discharge openings differ from one to another.

5. The ventilated bicycle saddle of claim 1, wherein the second portion of the air distribution channel is connected to more than one air discharge opening.

6. The ventilated bicycle saddle of claim 5, wherein the plurality of air-discharge openings are positioned in the front portion and rear portion of the seat surface; the air distribution channel is engaged with the plurality of air-discharge openings so that air flows through the plurality of air-discharge openings as the vehicle moves forwardly.

7. The ventilated bicycle saddle of claim 1, wherein the air-distribution channel extends along the longitudinal center axis essentially over the entire length of the saddle.

8. The ventilated bicycle saddle of claim 1, wherein the air distribution channel comprises a third portion having at least one aperture facing in the opposite direction of forward travel; said aperture in the third portion of the air distribution channel allows air to flow through the underside of the rear portion of the seat surface.

9. The ventilated bicycle saddle of claim 2, wherein the air-distribution channel is positioned between the seat surface and support base

10. The ventilated bicycle saddle of claim 1, wherein the air-intake component has a plurality of apertures.

11. A bicycle saddle comprising a seat surface on top of which a rider sits; said seat surface being positioned above a rigid support base; one or more molding materials being positioned underneath the seat surface; said molding materials being capable of molding the seat surface to a cyclist's individual shape.

12. The ventilated bicycle saddle of claim 11 wherein the molding materials comprise silicon, polyurethane gel, silica foam, polyol or any combination thereof.
